(19) United States
(12) Patent Application Publication
(10) Pub. No.: US 2012/0096002 A1
(43) Pub. Date: Apr. 19, 2012

(54) SYSTEMS AND METHODS FOR GENERATING AND MANAGING A UNIVERSAL SOCIAL GRAPH DATABASE

(75) Inventors: Timothy Patrick Sheehan, Decatur, GA (US); Christian Michael Bates, Wanship, UT (US); Paul Samuel Stevens, JR., Salt Lake City, UT (US); Richard Stafford, Bountiful, UT (US)

(73) Assignee: 7 DEGREES, INC., Cottonwood Heights, UT (US)

(21) Appl. No.: 12/907,861

(22) Filed: Oct. 19, 2010

(51) Int. Cl. G06F 17/30

(52) U.S. Cl. 707/737; 707/803; 707/748; 707/E17.005; 707/E17.009; 707/E17.046

(57) ABSTRACT

A computer-implemented method for determining connections between entities includes receiving private information from a user, retrieving public information from publicly available sources, and matching the public information with the private information. The method also includes generating a graph database with the public and private information, determining connections between entities in the graph database, and determining strength of connectivity between entities in the graph database.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread use of computers has been accelerated by the increased use of computer networks, including the Internet. Many businesses use one or more computer networks to communicate and share data between the various computers connected to the networks. The productivity and efficiency of employees often requires human and computer interaction.

Users of computer technologies continue to demand that the efficiency of these technologies increase. These demands include demands to improve the ability to communicate with other users of computer technologies. For example, social networking websites allow users to communicate with each other. A user of these sites may establish “contacts” which may be family, friends, co-workers, acquaintances, friends of friends, etc. of the user. In addition, address book features of certain applications (such as email applications) allow a user to store contact information for family, friends, co-workers, etc. The user may access his/her address book to obtain contact information for an individual when he/she desires to contact that particular individual.

The increased ease of gathering information about people, places, activities, histories, and preferences has resulted in users creating large collections of information about the people they are connected to and the ways they are connected. The volume and organization of the information often leads to ineffective use of the information.

### SUMMARY

In one example, a computer-implemented method for determining connections between entities includes receiving private information from a user, retrieving public information from publicly available sources, and matching the public information with the private information. The method also includes generating a graph database with the public and private information, determining connections between entities in the graph database, and determining strength of connectivity between entities in the graph database.

The entities may include at least one of contacts, companies, government agency, education institutions, education degrees, job positions, interests, hobbies, and geographic locations. The method may also include continuously retrieving the public information and automatically updating the strength of connectivity. The method may include displaying a connection path representing the connections between entities. Retrieving public information may include accessing at least one commercial data source. Receiving private information may include receiving uploaded personal information about at least one contact.

Another example relates to a computer system configured to determine connections between entities. The computer system includes a processor, memory in electronic communication with the processor, and a universal social graph generating module. The universal social graph generating module is configured to receive private information from a user, retrieve public information from publicly available sources, match the public information with the private information, generate a graph database with the public and private information, determine connections between entities in the graph database, and determine strength of connectivity between entities in the graph database.

The universal social graph generating module may be further configured to continuously retrieve the public information and automatically update the strength of connectivity. The universal social graph generating module may be further configured to maintain ownership of each item of information as public information or private information. The universal social graph generating module may be further configured to receive private information from a plurality of users, and qualify the private information by user. The universal social graph generating module may be further configured to provide access to the strength of connectivity over the Internet.

A further example relates to a computer-program product for determining connections between entities. The computer-program product includes a computer-readable medium having instructions thereon. The instructions include code programmed to receive private information from a user, code programmed to retrieve public information from publicly available sources, and code programmed to match the public information with the private information. The instruction also include code programmed to generate a graph database with the public and private information, code programmed to determine connections between entities in the graph database, and code programmed to determine strength of connectivity between entities in the graph database.

The private information may include a plurality of contacts, and the code programmed to determine strength of connectivity between entities includes determining strength of connectivity between at least two of the plurality of contacts. The instructions may further comprise code programmed to continuously retrieve the public information and automatically update the strength of connectivity.

Another example relates to a computer-implemented method for determining connection strength between entities. The method includes receiving private information a user, retrieving public information from publicly available sources, and determining a relationship strength value between entities based on the private and public information.

The private information may include information about at least one of email communications and social network communications between the user and an entity. The public information may include at least one of work history information and education information. The entities may include at least one of a user, a user's contacts, companies, government agency, education institutions, education degrees, job positions, interests, hobbies, and geographic locations. The email communications may include frequency and timeframe of email communications, and social network communications include writing to, posting, tagging, written recommendations, and groups or interest identified through social networks.

Another example relates to a computer system configured to determine connection strength between entities. The computer system includes a processor, memory in electronic communication with the processor, and a connection value generating module. The connection value generating module may receive private information a user, retrieve public information from publicly available sources, and determine a relationship strength value between entities based on the private and public information.

The connection value generating module may be configured to continuously retrieve the public information and automatically update the relationship strength value. The relationship strength value may be a quantifiable computed value. The private information may include information from at least one of a user's email lists, contact management systems, and social networks.

A further example relates to a computer-program product for determining connection strength between a plurality of contacts and a user. The computer-program product includes a computer-readable medium having instructions thereon. The instructions include code programmed to receive private information a user, code programmed to retrieve public information from publicly available sources, and code programmed to determine a relationship strength value between entities based on the private and public information.

The private information may include information about at least one of email communications and social network communications. The public information may include at least one of work history information and education information.

Another example includes a computer-implemented method for managing contacts from at least one user. The method includes receiving private information from a first user for a first plurality of contacts, receiving private information from a second user for a second plurality of contacts, identifying common contacts in the first and second plurality of contacts, and aggregating private information for the common contacts.

The method may also include receiving public information relating to the first and second plurality of contacts, including the common contacts. The method may include determining a strength of connectivity between at least one of the first and second users and at least some of the first and second plurality of contacts. The method may include providing a defined sharing group that includes the first and second users, wherein private information for the contacts of all users in the defined sharing group is available to all users. The private information received from the first and second users may be tagged as originating from one of the first and second users. The method may include de-aggregating the aggregated private information for the common contacts.

Another aspect relates to a computer system configured to manage contacts from at least one user. The computer system includes a processor, memory in electronic communication with the processor, and a contact aggregation module. The contact aggregation module may be configured to receive private information from a first user for a first plurality of contacts, receive private information from a second user for a second plurality of contacts, identify common contacts in the first and second plurality of contacts, and aggregate private information for the common contacts.

The contact aggregation module may be configured to tag each contact to the first and second users and maintain ownership of the private information for each contact. The contact aggregation module may be configured to aggregate private information for the common contacts by identifying unique information for each of the common contacts. The contact aggregation module may be configured to receive public information relating to the first and second plurality of contacts, including the common contacts, and provide access publicly to any of the private information that is available as public information.

A further example relates to a computer-program product for managing contacts from at least one user, wherein the computer-program product includes a computer-readable medium having instructions thereon. The instructions include code programmed to receive private information from a first user for a first plurality of contacts, code programmed to receive private information from a second user for a second plurality of contacts, code programmed to identify common contacts in the first and second plurality of contacts, and code programmed to aggregate private information for the common contacts.

The instructions may further include code programmed to receive public information relating to the first and second plurality of contacts, including the common contacts. The instructions may further include code programmed to determine a strength of connectivity between at least one of the first and second users and at least some of the first and second plurality of contacts.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of universal social graph platform communicating with various data sources and distribution modules to implement the present systems and methods;

FIG. 2 is a node diagram illustrating example pathways to a target using the universal social graph platform of FIG. 1;

FIG. 3 is a block diagram illustrating one embodiment of a universal social graph platform operating with a connection value generating module;

FIG. 4 is a block diagram illustrating another embodiment of a universal social graph platform operating with a contact aggregation module;

FIG. 5A is a node diagram representing unconnected contacts of multiple users;

FIG. 5B is a node diagram representing aggregated contacts for multiple users of a defined group;

FIG. 6 is a flow diagram illustrating one embodiment of a method for generating a universal social graph database according to the block diagram of FIG. 1;

FIG. 7 is a flow diagram illustrating one embodiment of a method for generating a connection value for a contact according to the block diagram of FIG. 3;

FIG. 8 is a flow diagram illustrating one embodiment of a method for aggregating contact information according to the block diagram of FIG. 4;

FIG. 9 depicts a block diagram of a computer system suitable for implementing the present systems and methods; and

FIG. 10 is a block diagram depicting a network architecture in which client systems, as well as storage servers are coupled to a network.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

Online social network portals have gained popularity in recent years. Users of these networks may be members of multiple online social network portals. Examples of these portals may include LinkedIn®, XING®, Viadeo®, and FaceBook®. Each user of these various network portals may create and maintain a list of contacts. A user's list of contacts for a particular network portal may include family members, friends, co-workers, acquaintances, classmates, friends of friends, etc. that are also members of that particular network portal. For example, a member of the social network LinkedIn® may create a list of contacts that includes family members, friends, co-workers, acquaintances, classmates, friends of friends, etc. that are also members of LinkedIn®.

Social network portal users may also create and maintain a list of contacts in their personal offline networks. Examples of offline networks may include Outlook®, Lotus Notes®, Yahoo®, or any other relationship management system. These lists of contacts are commonly placed in an electronic address book associated with each relationship management system.

The total number of contacts across various social networks and offline networks has increased dramatically. A given user may have hundreds or even thousands of contacts, many of which are duplicated across the different social networks and offline networks. It is often difficult for users to keep track of the relevance of a given contact, the user's connection to the contact, and current information (e.g., address, phone, employer, job title, personal and professional events, etc.) for each contact.

The present disclosure provides a system that tracks public and private connections between people and provides connection and profile information as a software platform via the Internet and at least one application programming interface (API). The system may implement or generate at least one graph database. The graph database may be updated in real time. The system may be capable of being used on a large scale to power cloud or software as a service based application that services simultaneous users and run simultaneous algorithms. An example system implementing a graph database is described in U.S. application Ser. No. ______, entitled A DATA GRAPH CLOUD SYSTEM AND METHOD and filed on 19 Oct. 2010, which is incorporated herein in its entirety by this reference.

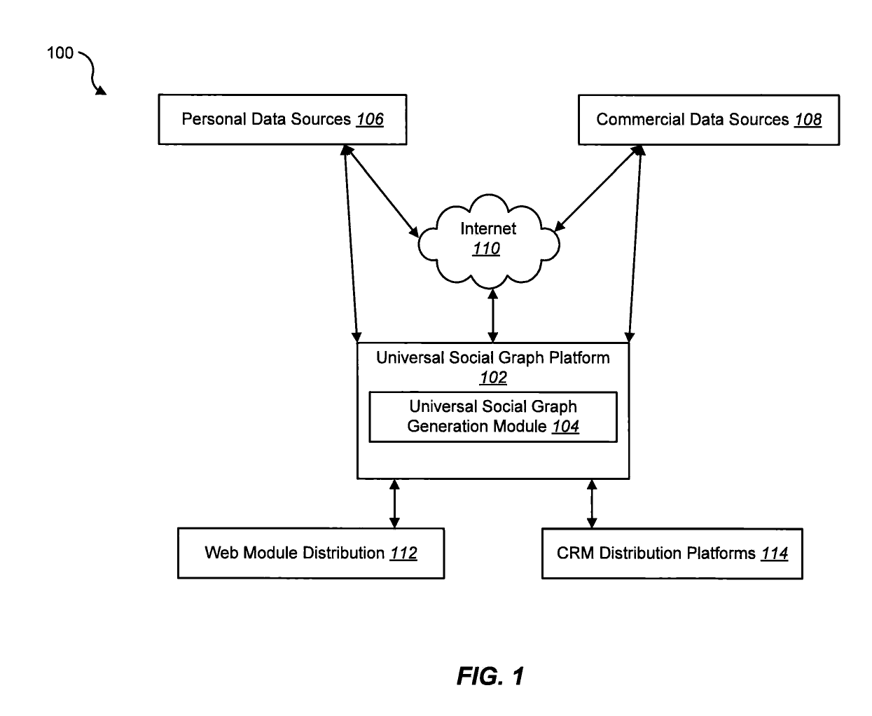

FIG. 1 is a block diagram illustrating one embodiment of a system 100 in which a universal social graph platform 102 communicates with a personal data source 106 and a commercial data source 108 to implement the present systems and methods. The universal social graph platform 102 may also communicate with web module distribution 112 and CRM (customer relationship management) distribution platforms 114. The universal social graph platform 102 may communicate via the Internet 110 or other communication mediums. The universal social graph platform 102 may include a universal social graph generating module 104.

The universal social graph generating module 104 may use private information from the personal data sources 106 and public information, such as information from the commercial data sources 108, to create at least one universal social graph database. The universal social graph generating module 104 may use software systems to create graph databases. The universal social graph generating module 104 may track publicly available information on people and other entities. The term “entities” in this context may be defined to include, for example, people, companies, government agency, education institutions, education degrees, job positions, interests, hobbies, and geographic locations. The term “entity” or “entities” may be inclusive of individuals, groups of individuals, organizations, attributes, hobbies, activities, or other types of information that can be collected and connected. An entity may include private information submitted by a user, such as information about the user (e.g., work history, education history, interests, personal attributes, and geographical location) and information about the user's contacts.

In one example, the universal social graph generating module 104 focuses primarily on information that connects people, including, for example, location, hobbies and employment history. However, in other examples, the information collected can be used to create connections in other ways such as between two inanimate entities such as two companies. While the examples that follow herein focus primarily on a user's contacts and other private information as the entity for which connections are determined, other types of entities may be used.

The universal social graph generating module 104 may identify and normalize information and establish connections between entities based on this information. The public information available from the commercial data sources 108 and other publicly available sources is typically constantly changing and being updated from, for example, targeted data source updates and real-time and on-the-go Internet queries.

Individuals and enterprises may upload private information from the personal data sources 106 into the universal social graph generating module 104. The universal social graph generating module 104 may be operable to disambiguate and normalize the information about people and match that information with publicly available information about people. Ownership of each item of information may be maintained as public or private based on the source of that information. Private ownership may be qualified by an individual contributor. The public information may be gathered from public sources, such as the commercial data sources 108 and be ingested into a graph database using algorithms that allow the universal social graph generating module 104 to compute strength of connectivity between individuals.

The output from the universal social graph generating module 104 may be a constructed network of people and their private and public connections. The output may be in the form of a graph database. This constructed network may be possible without each person in the system having opted into the network and intentionally contributed their public information. Contributions of private information are typically authorized by each user who accesses the graph database. The private information may include as little as a person's name, such as the user's name. The output is typically made available for users to search, append, and use to find information on and connections to other people via, for example, the web module distribution 112 and CRM distribution platform 114.

Typically, the universal social graph generating module 104 communicates with the personal data sources 106, commercial data sources 108, web module distributions 112 and CRM distribution platform 114 via the Internet 110. In some arrangements, any one of the personal data sources 106, commercial data sources 108, web module distribution 112 and CRM distribution platforms 114 may be directly connected to the universal social graph platform 102 and/or the universal social graph generating module 104 rather than a connection via the Internet 110.

The universal social graph database created by the universal social graph module 104 is a connected network of people and entities that connect them. The universal social graph database may contain billions of people in associated relationships. A full detail of the connections between people may be maintained in a graph database maintained on the universal social graph module 104. Data may be added to the graph database in real time. Typically, real time searches to find people and connections between people are available on the graph database using the universal social graph generating module 104.

The public information available to the universal social graph module 104 may be provided, at least in part, through the commercial data sources 108 and information available on the Internet 110 and other publicly available sources. The public information may be organized as a public graph database that includes information about people and entities that connect them. The public graph database typically contains all information that can be gathered from public data sources. The public graph database is typically an open network that does not require user contribution. The public graph database usually includes entity disambiguation across multiple data sources. In order to provide a true connected system, nodes in the public graph database are uniquely identified across all publicly available input data sources. This construction allows for connectivity of entities and people in a way that allows traversal without running into duplication.

In a public graph database, people or other entities are stored as nodes in the graph with connections to associated entities. People are connected to each other through the associated entities. Any user of the system 100 is typically allowed to view and traverse relationships made available through publicly available data or information.

The information available through the personal data sources 106 may be constructed as a private graph database. This information and connections between people available from the personal data sources 106 may be formed as a result of the privately contributed information. This privately contributed information is available to the user and anyone the user has selected to share their private/personal information. The universal social graph platform 102 and associated universal social graph generating module 104 may maintain information on many different private graph databases and their connection points into the public graph database. Private graph databases may be merged into or separated from other private graph databases based on user access rights (e.g., user rights maintained on arcs between nodes in the graph databases).

The private graph databases may include software system integrations with other systems that store individual enterprise information about people and contacts that allow for automatic uploading and syncing of private information on people. The private graph databases may include private information that is meshed with the public graph database information. The nodes are identified as the same between the public and private graph databases to permit a connection from nodes in the private graph database to the public graph database.

In some examples, the public and private information is collected into a single master graph database. In other examples, separate public and private graph databases are constructed for each of the public information and the private information.

Private networks in which permissions are extended between different private graph databases may be shared within groups of users. Private connections may be made and can be traversed in the private graph databases by users with private access to the information that created the connection in the private graph database. Private access may be obtained by ownership or by granting through sharing rights.

The universal social graph generating module 104 tracks individual ownership of information that connects people. The universal social graph generating module 104 provides an option for users to share their private information with other users. Sharing of private information opens up the relationships owned by the user to others who are sharing in this group or globally sharing. Users may also opt to make private information public so that the private information becomes part of the public graph database.

One aspect of the system 100 is that the information collected by the universal social graph generating module 104 is comprehensive and current. The graph database maintained by the universal social graph generating module 104 is preferably kept up to date with the personal data sources 106 and commercial data sources 108 and other information available publicly. One way to improve the collection of current and up-to-date information is to provide recurring data source updates. Public data may be continuously updated through an automated process. Searches for people in the system may trigger Internet searches to retrieve targeted profiles and infer people and relationships from targeted search results using any available search engine. The Internet may be constantly monitored for more information on existing public and private people and/or information in the system 100 and also identify new public people and/or information to add to the system 100.

Updates to public information may affect many aspects of the system 100. For example, any nodes in a private graph database may be updated with changed public information. Private data may also be continuously updated as the personal data sources 106 may be continuously synchronized with the universal social graph generating module 104.

The universal social graph module 104 may also provide profiles and connection paths between entities (e.g., connections between people). These profiles may contain searching and analytics. The searching may include looking up people in a variety of attributes, such as their location or places they have worked. The analytics may include real time path finding to show how anyone in the universal social graph database, whether private or public, is connected. The analytics may use a dynamic model to enable applying user preferences to the search and user criteria for finding the strongest connections.

Information in the universal social graph database may be maintained as connections between entities. The connection information may be presented visually to the user via any desired format including, for example, the web module distribution 112 and CRM distribution platforms 114. The universal social graph generating module 104 may present information as, for example, an XML, text description or other format that may be optimized for certain users and applications. The visual presentation of the information provided by the universal social graph generating module 104 may include, for example, different node sizes, colors, shapes, screen locations, and node descriptions. Relationships and arcs between nodes may have different, for example, sizes, shapes, colors, and descriptions that improve the visual presentation.

The universal social graph generating module 104 may capture all relationships with associated levels of privacy. Typically, every user accessing the universal social graph database may see and traverse all publicly available data. Users may also see and traverse information they own or information owned by someone that has been given permission to share.

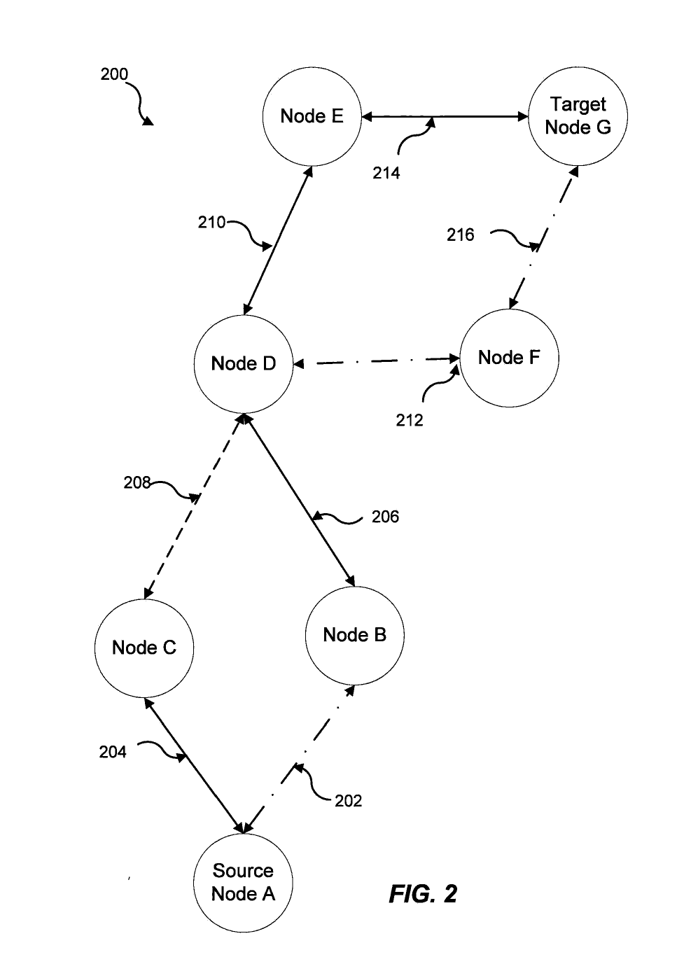

Referring to FIG. 2, an example connection pathway web 200 provides a visual representation of an output from the universal social graph generating module 104 includes a plurality of nodes and connecting arcs. The nodes are labeled Node A-G. The plurality of connecting arcs 202, 204, 206, 208, 210, 212, 214, 216 connect the Nodes A-G to provide a connection path between a source Node A and a target Node G. The solid line connecting arcs 204, 206, 210, 214 represent public relationships between nodes, meaning any user can see and traverse those arcs. The broken lines of connecting arcs 202, 212, 216 represent private relationships contributed by User 1. The broken line of connecting arc 208 represents a private relationship contributed by User 2.

If User 1 runs a search for target G, the user will see two pieces of information on Node G because the relationship from Node G to Node E is public, the relationship from Node G to Node F is contributed to User 1 (so can be seen). If User 2 or a User 3 views Node G, they will only see the relationship to Node E. If User 1 then runs a path from Node A to Node G, two paths exist. A first path traverses connecting arcs 202, 206, 210, 214, and a second path traverses connecting arcs 202, 206, 212, 216. If User 2 runs a path from Node A to Node G, User 2 would see one path along connecting arcs 204, 208, 210, 214. User 2 does not see the relationship between Node A and Node B or between Node D and Node F, and therefore cannot follow those paths. If a User 3 runs a path from Node A to Node G, there are no results.

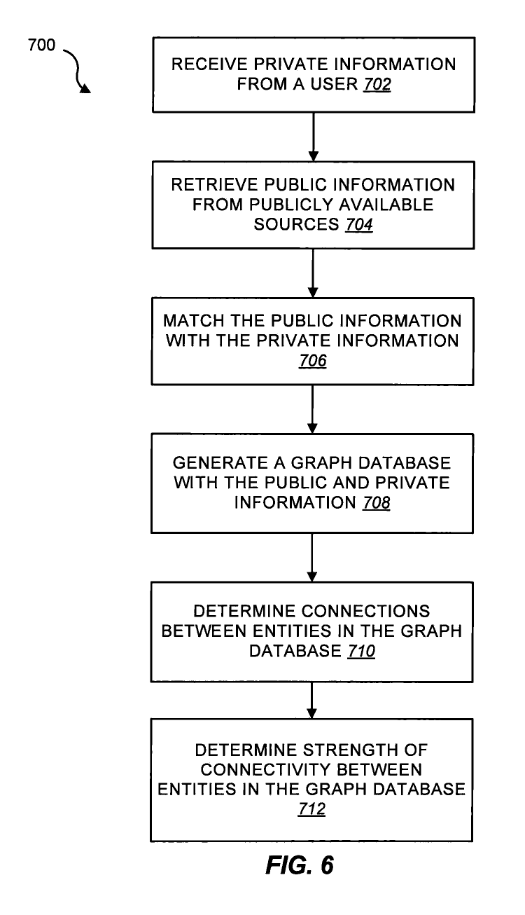

Referring now to FIG. 6, an example method utilizing the system 100 of FIG. 1 is shown and described. Method 700 includes a first operational step 702 of receiving private information from a user. In a further operational step 704, the method includes retrieving public information from publicly available sources. The method includes matching the public information with the private information in a further operational step 706. In a following operational step 708, the method includes generating a graph database with the public and private information. In an operational step 710, the method includes determining connections between entities in the graph database. The method includes determining strength of connectivity between entities in the graph database in an operational step 712. Additional steps may be added to the method 700, or removed from the method 700 in various applications. Furthermore, the method steps set forth in the attached figures and explained throughout may be performed in any desired order.

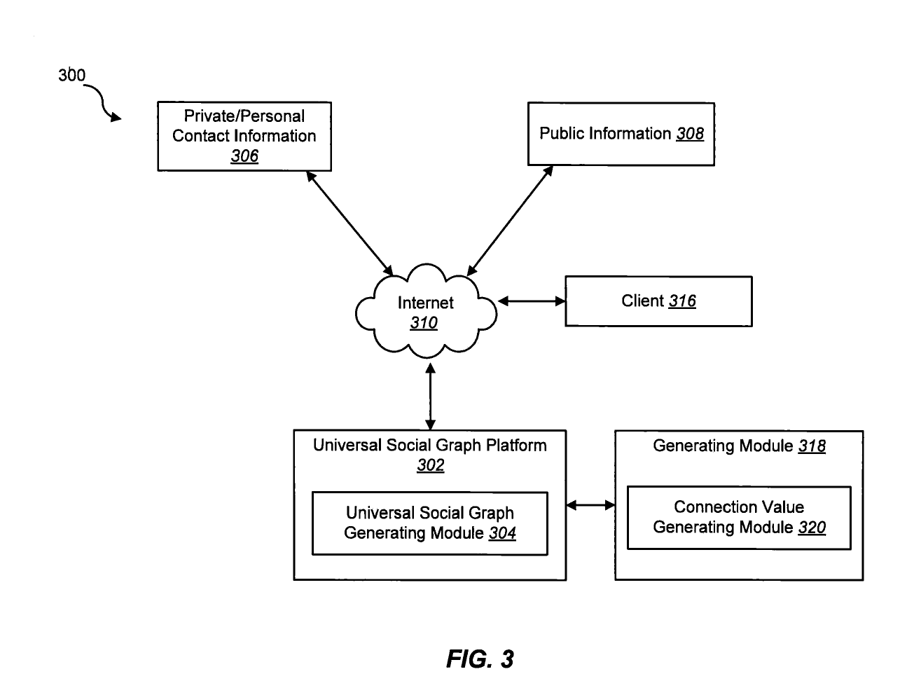

Referring now to FIG. 3, another example system 300 is shown and described. The system 300 includes a universal social graph platform 302 having a universal social graph generating module 304. Private/personal contact information 306 and public information 308 are connected to the universal social graph platform 302 via the Internet 310. Alternatively, the private/personal contact information 306 and public information 308 may be connected to the universal social graph platform 302 directly by bypassing the Internet 310 similar to the arrangement of system 100 shown in FIG. 1.

The system 300 may also include a client 316. The client 316 may provide access by a user to the universal social graph platform 302. The client 316 may include, for example, a personal computer (PC), a laptop, a personal digital assistant (PDA), smart phone, or any other type of communications or computing device.

The system 300 may also include a generating model 318 that includes a connection value generating module 320. The connection value generating module 320 may be used to detect the strength and quality of the relationship between people in a universal social graph database that has been generated by the universal social graph generating module 304. The strength and quality of a relationship may be based on, for example, a user's communication patterns (e-mail communications, tweeting, instant messaging, etc.) and other public and private information used to connect two or more people.

Some known systems allow users to send and receive invitations to connect and communicate with other users. These systems typically record very little information on how you know each person and do not capture all the ways that various users are connected. As users accept invitations to connect on social networks from other users, they have little knowledge of a connection to other users. It is becoming increasingly important to identify the strength of relationship between users and see how that relationship is maintained or changes over time. Typically, it is not reasonable to require users to tell each other or be able to identify the strength of their relationship directly. This information is usually inferred from activity that is public or can be detected from each user's interactions via various connections between users.

The system 300 may include a software system that permits users to upload and synchronize their personal contact information from a number of existing techniques of connecting, storing, and communicating with contacts. This may include personal contact information available via, for example, e-mail (e.g., Gmail and Outlook), contact management systems (e.g., Act!, Outlook), and social networks (e.g., Facebook, LinkedIn, Twitter). Each contact may be uploaded through native interactions (e.g., Act! and Outlook) or use of provided APIs (e.g., Gmail, Facebook, LinkedIn) if available.

By using methods available in the integrations and APIs, a number of factors may be studied to determine the strength of connection between the user and each contact. Additionally, the strength of connection between various contacts may also be determined. Additionally, each contact may be matched to public and private information via the universal social graph generating module 304. All of the private and public information collected from the integration in combination with the public information about both users and the contacts maintained by the system 300 may be used to determine a strength of connectivity from the user to each contact. The strength of the connectivity between each of the contacts may also be determined. Various factors using private system specific integration information include, for example, frequency of e-mail, last date of e-mail, communications on social networks by writing to or posting, communications on social networks by tagging, communications on social networks by writing a recommendation, or common groups or interests on a social network.

The combination of public and private information available via the private/personal contact information 306 and public information 308 may be used. This combination of information may include matching each contact to a public or private profile maintained by the system 300 with, for example, work and education history and other information that can connect entities. Various connections between people or contacts may be determined using, for example, common work history, common work history with intersecting timelines, common work history with similar areas of focus, common work history with similar position or level in a company, common work history of company size, frequency of common work history, common education history, education degrees and focus, education timelines, and education institution or institution size.

Additional information gathered by the system 300 via the Internet may be used to categorize and further define strength of connectivity. Such additional information may include shared hobbies and interests as determined from personal profiles on the Internet and related news articles profiling individuals, and any facts found on the Internet that can connect people.

The strength of connectivity may be reported as a quantifiable computed or determined value. This quantifiable computed value may be used as a search algorithm as part of the search criteria. This quantifiable computed value may also be used in a graph traversal for the strength of a connection. The quantifiable computed value may be generated using the connection value generating module 320. The strength of connectivity may be represented in other ways besides a quantifiable value. For example, the strength of connectivity may be represented with a color code, a symbol, audible tone, or a chronological presentation, or any combination thereof.

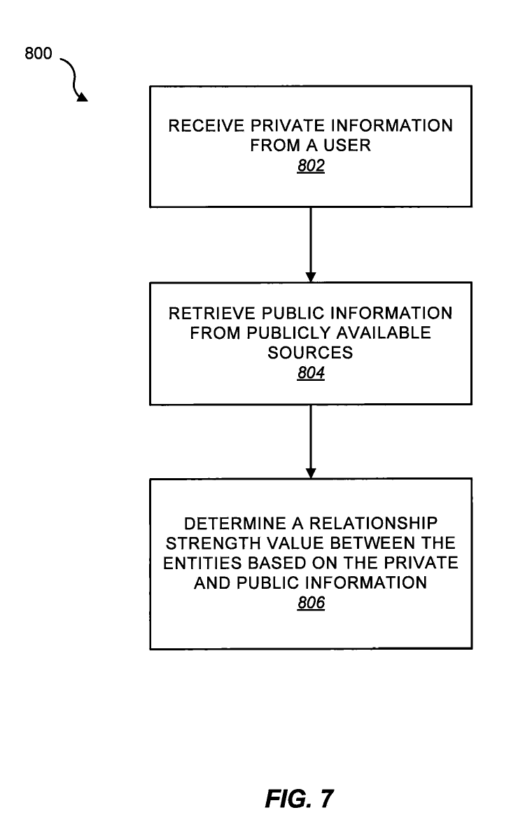

Referring to FIG. 7, an example method 800 implementing the system 300 may be implemented. The method 800 includes a first operational step 802 of receiving private information from a user. In another operational step 804, the method includes retrieving public information from publicly available sources. The method 800 includes determining relationship strength values between entities based on the private and public information in an operational step 806.

The determined connection strength between entities may be represented as a number, such as a number between 0 and 100 wherein 0 is the lowest strength of connection and 100 is the greatest strength of connection. The connection strength may be further broken down into different subcomponents presented to the user wherein the subcomponents include, for example, private or public information, or other categories such as, for example, work history, job description, education, communications, or common relationships. The connection strength may be represented in a variety of different formats including, for example, charts, graphs, and connection pathway webs (e.g., connection pathway web 200).

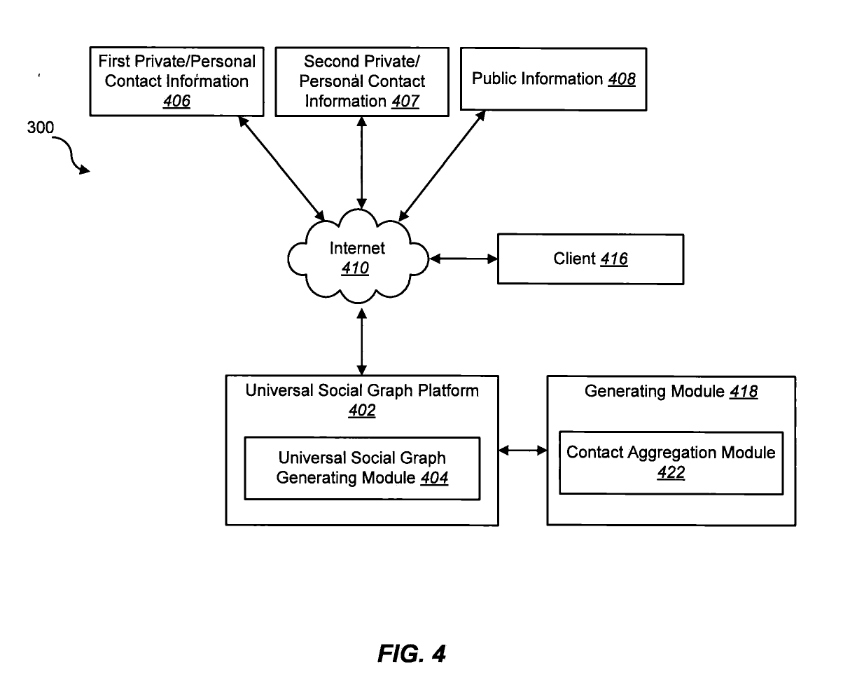

Referring now to FIG. 4, another example system 400 is shown and described. This system 400 may include a universal social graph module 404 having a universal social graph generating module 404. First and second private/personal contact information 406, 407 and public information 408 may be communicated to the universal social graph module 404. The Internet 410 may be one means of communicating between the information 406-408 and the universal social graph module 404. In other arrangements, the information 406-408 may be directly delivered to the universal social graph module 404 in other ways besides the Internet 410.

The system 400 may also include a client 416 and a generating module 418 having a contact aggregation module 422. The client 416 may provide access by a user to a universal social graph database generated by the universal social graph module 404. The client 416 may be, for example a personal computer (PC), a laptop, a personal digital assistant (PDA), a smart phone, or any other type of computing or communication device.

The contact aggregation module 422 may be used in combination with the universal social graph generating module 404 to aggregate and de-aggregate contact information provided from any of the private/personal contact information 406, 407 and public information 408 as will be further described below.

The system 400 may be used for individuals or groups of people to leverage each other's contact information without having to opt in to a closed social network or invite every contact to share or join. This system 400 may permit users to upload their own contacts and other personal/private information via one of the first or second private/personal contact information 406, 407 to the universal social graph module 404. These contacts are then available to other qualified users in a defined sharing group. Information for each contact may be connected to a graph database of public information to permit the universal social graph module 404 to leverage all contacts as a whole in targeted path finding.

Traditional software systems permit people working at the same corporation or in the same group to communicate in a closed environment and to collaborate and share. However, these systems do not typically have any mechanism to aggregate, normalize or disambiguate personal connections across the enterprise and to bridge those connections from the private, closed enterprise out to the public information available to those same people.

The system 400 provides an enterprise or private group to share and leverage personal contacts. The system 400 may be available for an enterprise level installation. This installation may permit an administrator to connect into the system that contains all participating members' personal connections through the software system. This installation may integrate systems such as, for example, social networks (e.g., Facebook, Twitter, Gmail), e-mail systems (e.g., software exchange server), contact management systems, CRM systems, and other places where enterprise members store their personal connection information. The system 400, in particular the universal social graph generating module 404 and contact aggregation module 422, may tag each contact by each individual owner in an enterprise and maintain the ownership information. Contacts may be disambiguated across the organization. Unique information may be aggregated for each contact so that one aggregated profile of all the unique information is created for each contact visible only with the defined group where permissions are granted.

It may be possible that a contact belongs to multiple sharing groups. In this case, all individual information may be assigned to one or more individual owners that contributed the information. If any owner of the information is sharing in a group, the group will see and can use that information. System 400 may also connect each contact into an overall system of public information. Any information that is validated as public is available outside (i.e., publicly) and regardless of the sharing group. However, any information that is not validated publicly can only be seen and used by the owner and any sharing users. This system may maintain a single entity for each person and maintain privacy through tracking individual information on each person by source and owner.

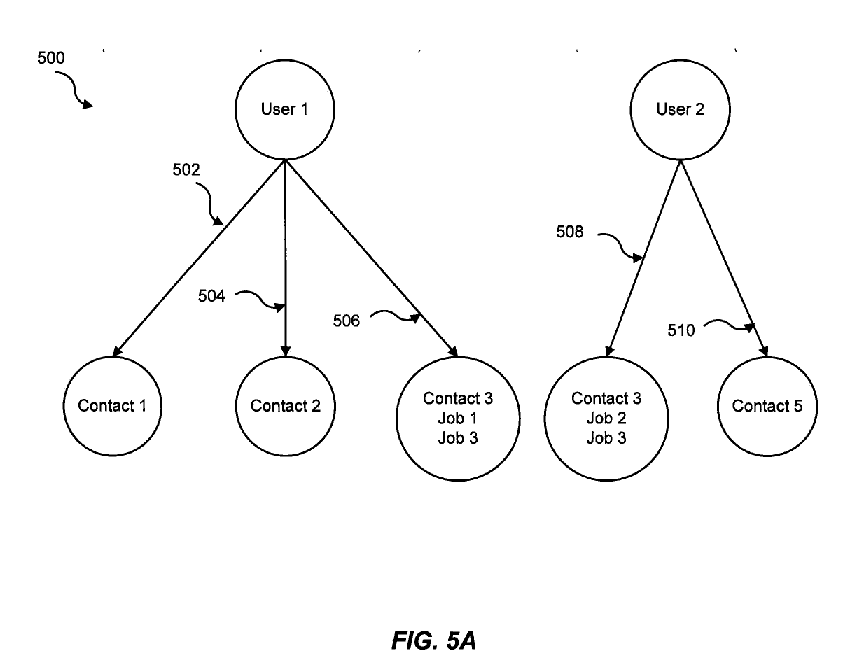

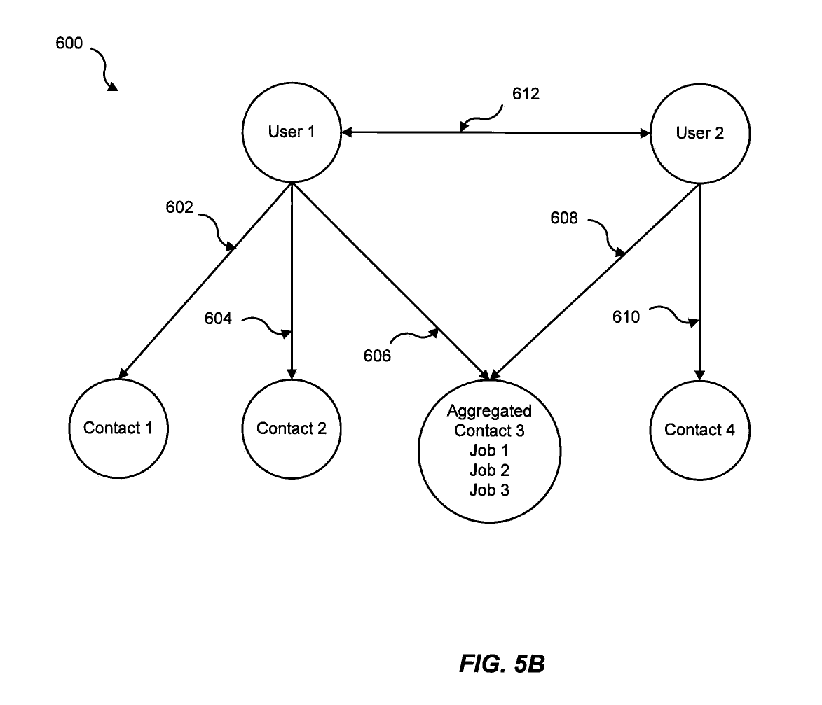

Referring to FIGS. 5A and 5B, an example of a plurality of contacts available through Users 1 and 2 is shown. A connection pathway web 500 is shown in FIG. 5A having a User 1 with Contacts 1-3, wherein Contact 3 has information about jobs 1 and 3. User 2 has Contacts 3 and 5, wherein Contact 3 has information about jobs 2 and 3. User 1 may be connected to its Contacts via arcs 502, 504, 506. User 2 may be connected to Contacts 3 and 5 via arcs 508 and 510.

Referring to FIG. 5B, the contact aggregation module 422 may operate to aggregate information about the Contacts in a connection pathway web 600. The contact aggregation module 422 may operate in combination with the universal social graph generating module 404 to provide access to all of the Contacts available from each of the Users 1 and 2. User 1 may now have access to Contacts 1, 2 and 3 via arcs 602, 604, 606 and may also have access to Contacts 3 and 4 via arcs 612, 608, 610. Furthermore, information about Contact 3 may be aggregated so that information about jobs 1, 2 and 3 is available to both Users 1 and 2 via arcs 606, 608, respectively.

The contact aggregation module 422 may also be operable to de-aggregate the job information about Contact 3 if either User 1 or User 2 opts out of the sharing group that provides permission to share information about Contact 3 originally available by Users 1 and 2. The contact aggregation module 422 may operate to de-aggregate and unassociated Users 1 and 2 back into the arrangement shown in FIG. 5A as connection pathway web 500.

The system 400 may be used, for example, to aggregate contacts across a defined group, create a master consolidated profile for each unique contact, track ownership and group access, maintain privacy for viewing, and provide a pathway for finding information in a graph database.

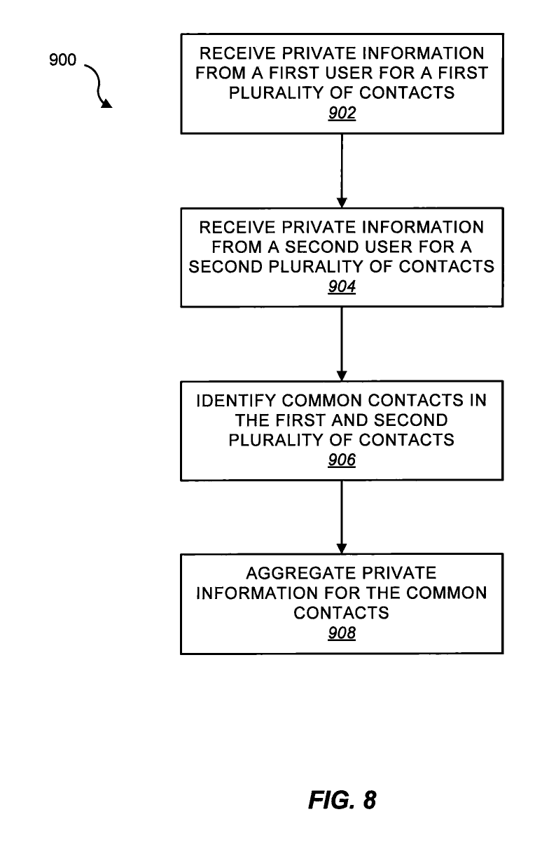

Referring to FIG. 8, an example method 900 implementing the system 400 is shown and described. The method 900 may include a first operational step 902 of receiving private information from a first user for a first plurality of contacts. In a further operational step 904, the method includes receiving private information from a second user for a second plurality of contacts. The method may include identifying common contacts in the first and second plurality of contacts in another operational step 906. In a further operational step 908, the method includes aggregating private information for the common contacts.

The additional method steps for method 900 may include de-aggregating the private information for the common contacts, maintaining ownership of private information for the common contacts, providing security and privacy for viewing of private information for only those with permissions, and providing a pathway for finding information in the graph database.

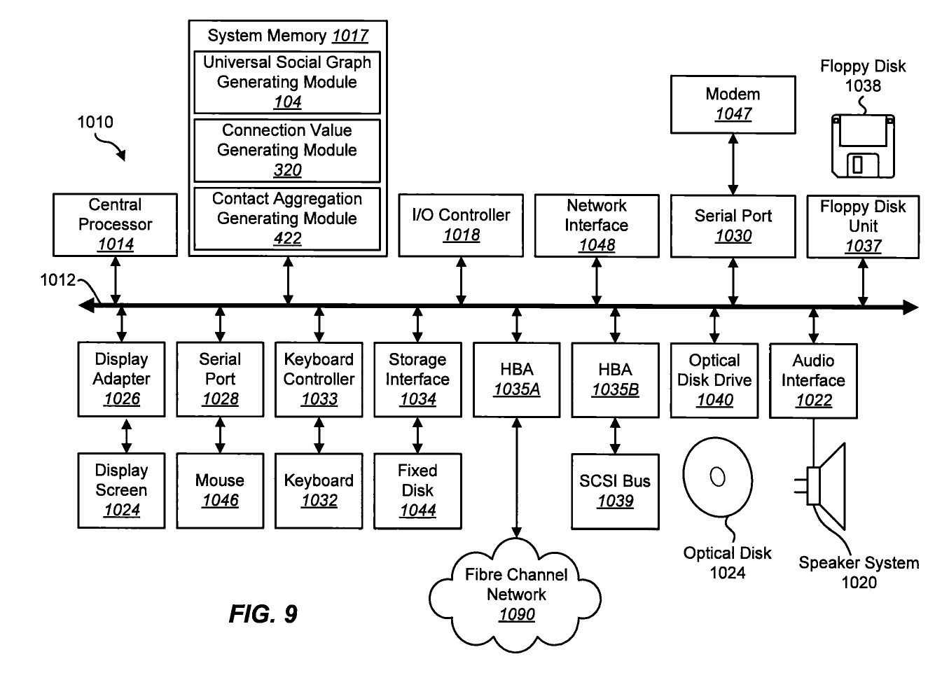

FIG. 9 depicts a block diagram of a computer system 1010 suitable for implementing the present systems and methods. Computer system 1010 includes a bus 1012 which interconnects major subsystems of computer system 1010, such as a central processor 1014, a system memory 1017 (typically RAM, but which may also include ROM, flash RAM, or the like), an input/output controller 1018, an external audio device, such as a speaker system 1020 via an audio output interface 1022, an external device, such as a display screen 1024 via display adapter 1026, serial ports 1028 and 1030, a keyboard 1032 (interfaced with a keyboard controller 1033), a storage interface 1034, a floppy disk drive 1037 operative to receive a floppy disk 1038, a host bus adapter (HBA) interface card 1035A operative to connect with a Fibre Channel network 1090, a host bus adapter (HBA) interface card 1035B operative to connect to a SCSI bus 1039, and an optical disk drive 1040 operative to receive an optical disk 1042. Also included are a mouse 1046 (or other point-and-click device, coupled to bus 1012 via serial port 1028), a modem 1047 (coupled to bus 1012 via serial port 1030), and a network interface 1048 (coupled directly to bus 1012).

Bus 1012 allows data communication between central processor 1014 and system memory 1017, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a universal social graph generating module 104, a connection value generating module 320, and a contact aggregation module 422 may be used to implement the present systems and methods may be stored within the system memory 1017. Applications resident with computer system 1010 are generally stored on and accessed via a computer readable medium, such as a hard disk drive (e.g., fixed disk 1044), an optical drive (e.g., optical drive 1040), a floppy disk unit 1037, or other storage medium. Additionally, applications can be in the form of electronic signals modulated in accordance with the application and data communication technology when accessed via network modem 1047 or interface 1048.

Storage interface 1034, as with the other storage interfaces of computer system 1010, can connect to a standard computer readable medium for storage and/or retrieval of information, such as a fixed disk drive 1044. Fixed disk drive 1044 may be a part of computer system 1010 or may be separate and accessed through other interface systems. Modem 1047 may provide a direct connection to a remote server via a telephone link or to the Internet via an internet service provider (ISP). Network interface 1048 may provide a direct connection to a remote server via a direct network link to the Internet via a POP (point of presence). Network interface 1048 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 9 need not be present to practice the present disclosure. The devices and subsystems can be interconnected in different ways from that shown in FIG. 9. The operation of a computer system such as that shown in FIG. 9 is readily known in the art and is not discussed in detail in this application. Code to implement the present disclosure can be stored in computer-readable storage media such as one or more of system memory 1017, fixed disk drive 1044, optical disk 1042, or floppy disk 1038. The operating system provided on computer system 1010 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

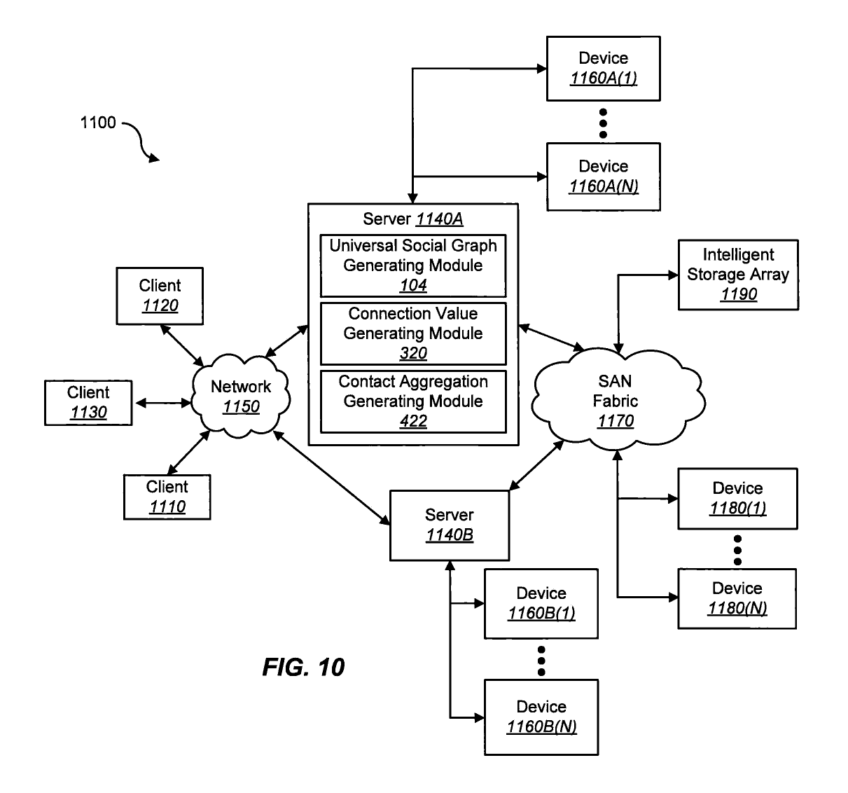

FIG. 10 is a block diagram depicting a network architecture 1100 in which client systems 1110, 1120 and 1130, as well as storage servers 1140A and 1140B (any of which can be implemented using computer system 1110), are coupled to a network 1150. In one embodiment, the universal social graph generating module 104, connection value generating module 320, and contact aggregation module 422 may be located within a server 1240A, 1240B to implement the present systems and methods. The storage server 1140A is further depicted as having storage devices 1160A(1)-(N) directly attached, and storage server 1140B is depicted with storage devices 1160B(1)-(N) directly attached. SAN fabric 1170 supports access to storage devices 1180(1)-(N) by storage servers 1140A and 1140B, and so by client systems 1110, 1120 and 1130 via network 1150. Intelligent storage array 1190 is also shown as an example of a specific storage device accessible via SAN fabric 1170.

With reference to computer system 1010, modem 1047, network interface 1048 or some other method can be used to provide connectivity from each of client computer systems 1110, 1120 and 1130 to network 1150. Client systems 1110, 1120 and 1130 are able to access information on storage server 1140A or 1140B using, for example, a web browser or other client software (not shown). Such a client allows client systems 1110, 1120 and 1130 to access data hosted by storage server 1140A or 1140B or one of storage devices 1160A(1)-(N), 1160B(1)-(N), 1180(1)-(N) or intelligent storage array 1190. FIG. 10 depicts the use of a network such as the Internet for exchanging data, but the present disclosure is not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method for determining connections between entities, comprising:
receiving private information from a user;
retrieving public information from publicly available sources;
matching the public information with the private information;
generating a graph database with the public and private information;
determining connections between entities in the graph database;
determining strength of connectivity between entities in the graph database.

2. The method of claim 1, wherein the entities include at least one of contacts, companies, government agency, education institutions, education degrees, job positions, interests, hobbies, and geographic locations.

3. The method of claim 1, further comprising continuously retrieving the public information and automatically updating the strength of connectivity.

4. The method of claim 1, further comprising displaying a connection path representing the connections between entities.

5. The method of claim 1, wherein retrieving public information includes accessing at least one commercial data source.

6. The method of claim 1, wherein receiving private information includes receiving uploaded personal information about at least one contact.

7. A computer system configured to determine connections between entities, comprising:
a processor;
memory in electronic communication with the processor;
a universal social graph generating module configured to:
receive private information from a user;
retrieve public information from publicly available sources;
match the public information with the private information;
generate a graph database with the public and private information;
determine connections between entities in the graph database;
determine strength of connectivity between entities in the graph database.

8. The computer system of claim 7, wherein the universal social graph generating module is further configured to continuously retrieve the public information and automatically update the strength of connectivity.

9. The computer system of claim 7, wherein the universal social graph generating module is further configured to maintain ownership of each item of information as public information or private information.

10. The computer system of claim 9, wherein the universal social graph generating module is further configured to receive private information from a plurality of users, and qualify the private information by user.

11. The computer system of claim 7, wherein the universal social graph generating module is further configured to provide access to the strength of connectivity over the Internet

12. A computer-program product for determining connections between entities, the computer-program product comprising a computer-readable medium having instructions thereon, the instructions comprising:
code programmed to receive private information from a user;
code programmed to retrieve public information from publicly available sources;
code programmed to match the public information with the private information;
code programmed to generate a graph database with the public and private information;
code programmed to determine connections between entities in the graph database;
code programmed to determine strength of connectivity between entities in the graph database.

13. The computer-program product of claim 12, wherein the private information includes a plurality of contacts, and the code programmed to determine strength of connectivity between entities includes determining strength of connectivity between at least two of the plurality of contacts.

14. The computer-program product of claim 12, wherein the instructions further comprise code programmed to continuously retrieve the public information and automatically update the strength of connectivity.

15. A computer-implemented method for determining connection strength between entities, comprising:
receiving private information a user;
retrieving public information from publicly available sources;
determining a relationship strength value between entities based on the private and public information.

16. The method of claim 15, wherein the private information comprises information about at least one of email communications and social network communications between the user and an entity.

17. The method of claim 15, wherein the public information comprises at least one of work history information and education information.

18. The method of claim 15, wherein the entities include at least one of a user, a user's contacts, companies, government agency, education institutions, education degrees, job positions, interests, hobbies, and geographic locations.

19. The method of claim 16, wherein email communications include frequency and timeframe of email communications, and social network communications include writing to, posting, tagging, written recommendations, and groups or interest identified through social networks.

20. A computer system configured to determine connection strength between entities, comprising:
a processor;
memory in electronic communication with the processor;
a connection value generating module configured to:
receive private information a user;
retrieve public information from publicly available sources;
determine a relationship strength value between entities based on the private and public information.

21. The computer system of claim 20, wherein the connection value generating module is configured to continuously retrieve the public information and automatically update the relationship strength value.

22. The computer system of claim 20, wherein the relationship strength value is a quantifiable computed value.

23. The computer system of claim 20, wherein the private information includes information from at least one of a user's email lists, contact management systems, and social networks.

24. A computer-program product for determining connection strength between a plurality of contacts and a user, the computer-program product comprising a computer-readable medium having instructions thereon, the instructions comprising:
code programmed to receive private information a user;
code programmed to retrieve public information from publicly available sources;
code programmed to determine a relationship strength value between entities based on the private and public information.

25. The computer-program product of claim 24, wherein the private information comprises information about at least one of email communications and social network communications.

26. The computer-program product of claim 24, wherein the public information comprises at least one of work history information and education information.

27. A computer-implemented method for managing information, comprising:
receiving private information from a first user for a first plurality of contacts;
receiving private information from a second user for a second plurality of contacts;
identifying common contacts in the first and second plurality of contacts;
aggregating private information for the common contacts.

28. The method of claim 27, further comprising receiving public information relating to the first and second plurality of contacts, including the common contacts.

29. The method of claim 27, further comprising determining a strength of connectivity between at least one of the first and second users and at least some of the first and second plurality of contacts.

30. The method of claim 27, further comprising providing a defined sharing group that includes the first and second users, wherein private information for the contacts of all users in the defined sharing group is available to all users.

31. The method of claim 27, wherein the private information received from the first and second users is tagged as originating from one of the first and second users.

32. The method of claim 31, further comprising de-aggregating the aggregated private information for the common contacts.

33. A computer system configured to manage information, comprising:
a processor;
memory in electronic communication with the processor;
a contact aggregation module configured to:
receive private information from a first user for a first plurality of contacts;
receive private information from a second user for a second plurality of contacts;
identify common contacts in the first and second plurality of contacts;
aggregate private information for the common contacts.

34. The computer system of claim 33, wherein the contact aggregation module is configured to tag each contact to the first and second users and maintain ownership of the private information for each contact.

35. The computer system of claim 33, wherein the contact aggregation module is configured to aggregate private information for the common contacts by identifying unique information for each of the common contacts.

36. The computer system of claim 33, wherein contact aggregation module is configured to receive public information relating to the first and second plurality of contacts, including the common contacts, and provide access publicly to any of the private information that is available as public information.

37. A computer-program product for managing information, the computer-program product comprising a computer-readable medium having instructions thereon, the instructions comprising:
code programmed to receive private information from a first user for a first plurality of contacts;
code programmed to receive private information from a second user for a second plurality of contacts;
code programmed to identify common contacts in the first and second plurality of contacts;
code programmed to aggregate private information for the common contacts.

38. The computer-program product of claim 37, wherein the instructions further comprise code programmed to receive public information relating to the first and second plurality of contacts, including the common contacts.

39. The computer-program product of claim 37, wherein the instructions further comprise code programmed to determine a strength of connectivity between at least one of the first and second users and at least some of the first and second plurality of contacts.
